(19) United States
(12) Patent Application Publication
(10) Pub. No.: US 2015/0184962 A1
(43) Pub. Date: Jul. 2, 2015

(54) METHOD AND APPARATUS FOR WEAPON CONTROL AND AUTHORIZATION

(71) Applicant: ROBERT VAN BURDINE, ARDMORE, TN (US)

(72) Inventor: ROBERT VAN BURDINE, ARDMORE, TN (US)

(21) Appl. No.: 14/142,874

(22) Filed: Dec. 29, 2013

(51) Int. Cl. F41A 17/06; E05B 65/46; G07C 9/00; A47B 81/00

(52) U.S. Cl. CPC F41A 17/063; A47B 81/00; E05B 65/46; G07C 9/00071; G07C 9/00039

(57) ABSTRACT

Apparatus for authorizing and de-authorizing a device such as a weapon is disclosed. The apparatus includes the electrical detection of a signal on the skin of the user, and optionally a radio signal from a central authorizing authority and the entering of a security code by the user. Upon receipt of the correct input, the weapon authorizes and is ready for use. If a loss of skin signal occurs, the weapon enters a safe state until reauthorized. Apparatus for generating the skin signal from both an ingestible and a skin-mounted apparatus are disclosed.

### CROSS-REFERENCE TO RELATED APPLICATIONS

This application claims benefit of U.S. Provisional Patent Application No. 61/747,571 filed on Dec. 31, 2012 and entitled “METHOD AND APPARATUS FOR WEAPON CONTROL AND AUTHORIZATION,” in the names of Robert Van Burdine, Dorothy Devine Burdine and Alfred Devine, which is hereby incorporated by reference in its entirety.

### BACKGROUND OF THE INVENTION

This invention relates to control and authorization for use of a device such as a weapon, and in particular to the apparatus and method for weapons control and authorization at the individual or group level, particularly in structured environments such as schools and military establishments.

This invention also relates to control and authorization for use, and in particular to the apparatus and method for control and authorization at the individual or group level, particularly in structured environments such as schools, military establishments, commercial vehicle operation and controlled living facilities.

Schools and other institutions where people regularly come and go are occasionally subject to assault by one or more armed assailants. While these attacks are rare in the United States, in other countries such as Israel, the incidence can be much higher. The results of such attacks are devastating, often resulting in the deaths of children and personnel. There is a clear consensus of the need to limit or prevent these attacks.

Some have advocated the use of armed guards, or even armed teachers, as a means of stopping such attacks before they can proceed to their devastating end. Others point to the issues of introducing weapons into the classroom environment.

School shootings clearly have a political impact, spurring some to ask for more stringent gun control laws. In the United States, the National Rifle Association is opposed to such laws, and some groups have called for fewer gun control laws in general, citing cases of armed students ending shootings and halting further loss of life, and claiming that the prohibitions against carrying a gun in schools do not deter the gunmen. They point to cases such as shootings at Columbine and Red Lake High Schools, where the presence of an armed police officer alone did not prevent the shootings.

Areas in the US have allowed “armed classrooms” in an attempt to deter or truncate future attacks, presumably by changing helpless victims into armed defenders. In 2008, Harrold Independent School District in Texas became the first public school district in the U.S. to allow teachers with state-issued firearm-carry permits to carry their arms in the classroom; special additional training and ricochet-resistant ammunition were required for participating teachers. Students at the University of Utah have been allowed to carry permitted concealed pistols since a State Supreme Court decision in 2006. In addition to Utah, Wisconsin and Mississippi each have legislation that allow students, faculty and employees to carry concealed weapons on their public university's campuses. Other states have enacted various legislations and rules in response to the need to defend the classroom.

The issue with arming teachers is the introduction of deadly force into the classroom that is present at all times. Control and security issues with these weapons, as well as clear regulation and authorization for the use of force remain current issues that are addressed by the present invention.

Other uses for the present invention include the control of authorization for any device such as vehicles and cook stoves. The control through authorization of times and periods for the operation of commercial transport such as over-the-road freight (18 wheelers), trains, taxis, and equipment is made possible through the present invention. Hunting regulation is facilitated by only allowing authorizable weapons and issuing authorizations for specific individuals for specific time periods. Security is provided through the present invention by the authorized use of security doors, and protection is afforded to the elderly or infirm by maintaining authorization over cook stoves and filling bath tubs that may cause a fire or water damage if inadvertently left unattended. This invention may also have applications in correctional facilities and military operations.

### SUMMARY OF THE INVENTION

The invention relates to an apparatus such as a weapon that senses the contact of an individual through capacitive, inductive or resistive means, and may require a security code that is entered by the individual. When such conditions are met an apparatus such as a weapon is authorized and loss of contact with the individual de-authorizes the apparatus. In this manner an individual with a correct security code can be authorized to fire the weapon, and another individual without a security code can not fire the weapon. If the weapon is taken from an authorized individual, the momentary loss of contact with the individual is detected and the weapon de-authorizes preventing its use. The invention may be further comprised of a received signal such as a radio signal, that is received by the weapon before authorization is complete, with the loss of the radio signal de-authorizing the weapon. In this case a central authority can control the use of weapons.

The invention also relates to apparatuses that generate an authorization signal on the skin of an individual, an operable device comprising of a receiving apparatus that will enable the device to be operated only when an authorizing signal is received through contact, and further optional security apparatus comprising of a containment device that restricts access by an authorized user until authorization is given by a controlling authority. The invention enables the operation, by authorized users, of devices such as vehicles, commercial transport, mobile field artillery, industrial equipment, missiles, aircraft, security doors, cooking equipment, medical devices, and tools.

The invention further relates to apparatuses that generate an authorization signal on the skin of an individual, a weapon comprised of a receiving apparatus that will enable the weapon to be operated only when an authorizing signal is received through contact with the user, and further security apparatus comprised of a containment device that restricts access by an authorized user until authorization is given by a controlling authority. The invention enables the introduction of weapons to a weapons free environment, such as a school, during times of attack, while, during normal operations, completely restricting access.

Embodiments of the invention provide for the safe storage of weapons and authorizing devices in a weapons free structured environment such as a school or classroom, the access to these items during times of authorized use such as an attack by an armed intruder, the authorization for use of the weapons by authorized individuals, and the de-authorization of the weapons after the threat has passed, enabling a plurality of security operations to be selected and controlled under different conditions. Embodiments of the invention provide a means of containment of weapons, access to weapons, authorization of weapons for use, and de-authorization of weapons. In particular embodiments, the invention includes a means to authorize the release and use of weapons from a central or distributed source. Authorizers such as security personnel, principals, or other empowered individuals may authorize the use of the weapons according to the security plan of the establishment.

In one embodiment of the invention, an apparatus for weapons authorization, an authorization device is strapped to the user or otherwise brought into contact with the skin of the user, a security code is entered into the authorization device by the user, upon entry of a valid security code the authorizing device may optionally check for detection of an authorizing radio signal and upon signal detection authorize the individual by generating an authorization signal on the skin of the user. When the user touches an authorizable weapon, the weapon detects the authorization signal and immediately converts from a safe to a dischargeable condition. For example, when the alarm is given alerting to an intrusion into a school, an authorization is given by the principals office or security officer. This authorization allows the opening of the weapons storage by a user entering their security code. The user takes an authorization device, straps it to themselves and enters their authorization code. The authorizing device then produces an authorization signal on the skin of the user.

The now fully authorized user selects a weapon from the weapons storage that is completely operational in the authorized users hands. If the authorized user loses contact with the weapon, the weapon is no longer operational as the authorization signal has been lost. If the authorizing device is removed from the authorized user, such as by an assailant, the loss of skin contact is detected and the authorization device deactivates stopping the authorization signal. In this manner an authorization device and authorizable weapon can not be taken from an authorized user and used against them or anyone else. A proper authorization code would have to be entered to re-activate the authorization signal, and optionally a specific radio authorization from the controlling office may have to be received to re-activate. Due to this the authorized weapon can be introduced into the classroom for use against an assailant without the risk of the weapon being accessible to or usable by anyone other than a fully authorized user under fully authorized conditions.

The apparatus has particular utility in the control and accessibility of weapons in environments such as schools, military bases, prisons, psychiatric wards, shooting ranges, security areas, military peace keeping operations, and other areas where control and availability of weapons is simultaneously required.

In the case of a prison, the 1.6 million inmates housed in the correctional facilities of the United States today pose a significant threat to the 493,100 men and women tasked to keep the peace in prison. The majority of these inmates are hardened criminals, some sentenced to life behind bars who have nothing to lose. A great many of these convicted felons are bent on little more than waging war within the confines of their facilities. They spend the majority of their day looking for methods to harm those whose job it is to supervise them. Weapons are crafted from everyday objects and create a highly charged hostile work environment. Into this environment enters the correctional officer who has only their uniform and their wits to keep themselves safe while being outnumbered 200 to 1.

If the guards who are physically in with the inmates were to carry a weapon (such as a firearm or Taser) , it would more than likely be taken away from them and then used against the officer or on other inmates. The ability to have a correctional officer armed with a weapon which could not be used against them in a closed environment would shift the balance of power back towards the establishment.

An example of this would be as follows: A correctional officer in the general population is armed with either a gun or a Taser and is called upon to break up a prison riot. This officer is equipped with the authorized weapon control and therefore is not in danger of losing his personal weapon in a usable condition to the inmates.

If the perpetrators of the riot were to disarm the officer, the only way the weapon could be used to hurt anyone would be as a bludgeon or as a blunt object. Additionally, the inmate who grabs the weapon and thinks he may use the weapon against the officer has now made a grave error. The fact that the firearm or Taser will not fire would disorient the inmate and could allow for the correctional officer to wrestle the perpetrator down and re-take the weapon which would be reauthorized and become functional as soon as the officer takes hold of it.

This scenario would be played out many times with the inmates never getting to use the stolen weapons. This act, over time, would deter the inmates from attempting to steal guard's weapons. This increased ability to physically stop the assault on either correctional facility personnel or other inmates in a closed environment would greatly enhance the control that the correctional facility has in the rehabilitation or incarceration of convicted felons.

This control of a weapon in a closed environment could be used in any law enforcement arena where there is the danger of an officer's weapon being taken from them and used against them or anyone else who may be in the vicinity.

In the law enforcement and correctional facility arena, an officer would have an authorization code which would activate the weapon's release for their service weapon or Taser. This would be followed by a daily code to continue to allow the officer to use their weapons whenever they are needed. If the officer is tasked with a SWAT role, then the officer would use a specific security code to allow for the use of additional more powerful weapons. This would require a monthly activation in order to allow for the officer to always be able to fire his weapon.

Another example of the use of the present invention is the ability of a state agency to control the use of a specific type of weapon during a hunting season, resulting in a much safer hunting season.

The method of this application is as follows: A civilian goes to a state controlled location or state sanctioned retailer to purchase a hunting license for a specific hunting season. Along with the required hunting tag, the proprietor also sells the hunter an authorization code which allows for the weapons authorization to last only the duration of the hunting season. If the season is to last for a three month period and the hunter has two deer tags, then the retailer provides to the hunter a security code control for a one month period. After the hunter registers his first deer “tag” at the retailer, then the hunter will then receive a second security code which will then allow the hunter to continue his hunting season.

This scenario would allow for a safety aspect which does not exist at this time. Currently, if the hunter leaves his rifle or firearm out and a young child or anyone else who might be around finds the weapon and handles it, the weapon could accidentally discharge resulting in grievous injury or even death.

Using the present invention, this tragedy could not occur. Anyone who handles the weapon and does not have the security code for the weapon control can not accidentally discharge the weapon. This assures the hunter that his family is completely safe while the hunter still has the ability to use the weapon for its intended purpose.

Additionally, with the use of the present invention, no one may steal a persons weapon and then be able to use the stolen weapon.

Finally, the present invention could be used to regulate the caliber and type of firearm that would be used in a specific hunting season. If the season requires that only a shotgun be used to hunt deer, then the weapon authorization would be geared to a shotgun for that season. This would require there be a differentiation in the controls for each caliber of weapon used by an individual hunter. This would have the added benefit in that poaching of a specific animal out of season would not be feasible.

The method in which the present invention would be utilized would vary depending on the application and occupation of the user. Each different user would need to follow a different protocol in order to utilize their weapons.

Overall, there would be an activation security code which would be active for a given period. The initial period authorization code would authorize the user to use a general weapon with an additional authorization code issued each month.

In the civilian hunting application, the user would need an activation code once a month or at the beginning of the specific hunting season with a periodic codes each day during the specific hunting season.

In a further civilian application, a homeowner who wishes to use a firearm in the defense of themselves or their residence would also have an authorization code for a given period, perhaps a year or five years. This code would be geared to the weapon which the homeowner chooses to keep as a defensive weapon. This application would also have a side benefit in that there would not be an accidental discharge by a member of the household who has not put on the authorizing device and entered the proper code.

Elderly and infirm persons may also benefit from the present invention. For example, a forgetful person may walk away and forget to maintain cognizance over cook stoves and filling bath tubs that may cause fire or water damage if inadvertently left unattended. In the case of a cook stove, the authorized individual would make contact with the authorization sensor of the cook top, and the cook top would continue to operate for a predetermined period, or variably depending on the heat level selected, shutting down if not revisited within the determined time. Programmable cook tops could be initiated by the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art, and should not be interpreted in an idealized or overly formal sense unless expressly so defined herein. Well-known functions or constructions may not be described in detail for brevity and/or clarity.

### BRIEF DESCRIPTION OF THE DRAWINGS

FIG. 1 is a profile view of an authorizable weapon;

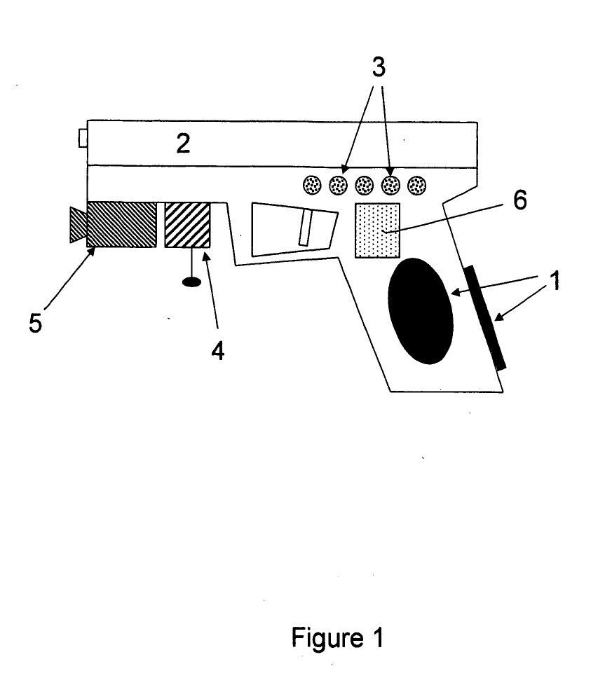

FIG. 2 is a flow chart for a method of weapon authorization;

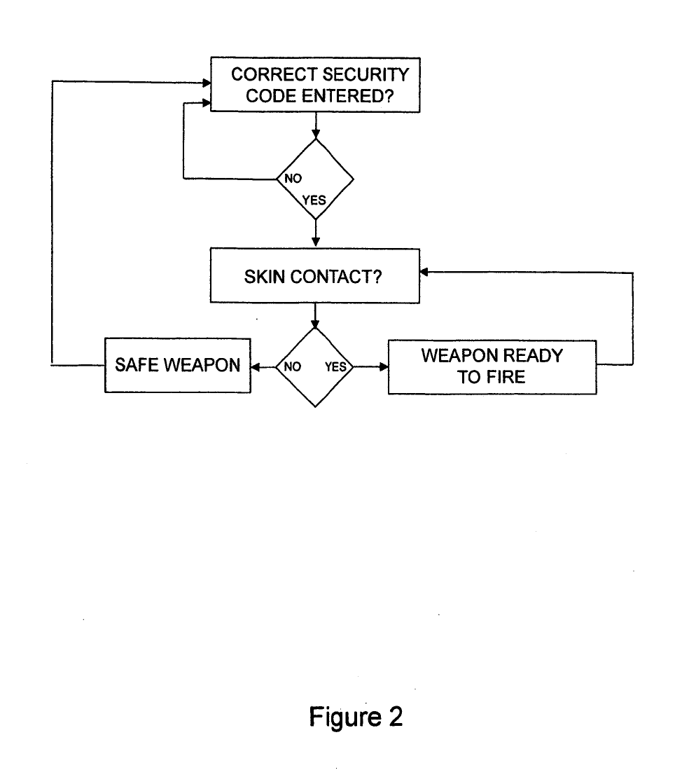

FIG. 3 is a flow chart for a method of weapon authorization;

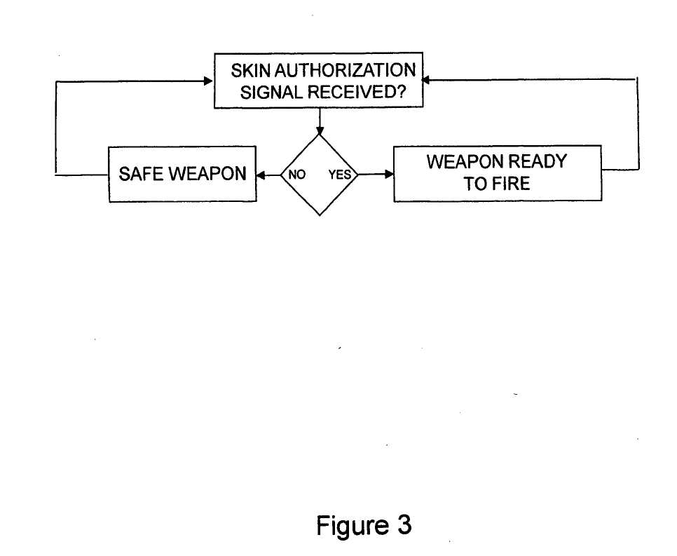

FIG. 4 is a flow chart for a method of weapon authorization;

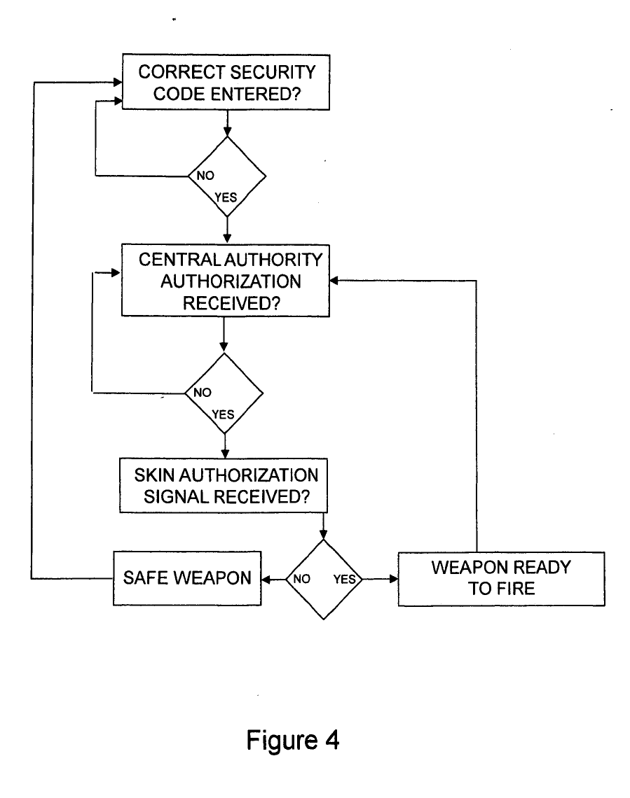

FIG. 5 is a cross-sectional view of an ingestible skin signal generator;

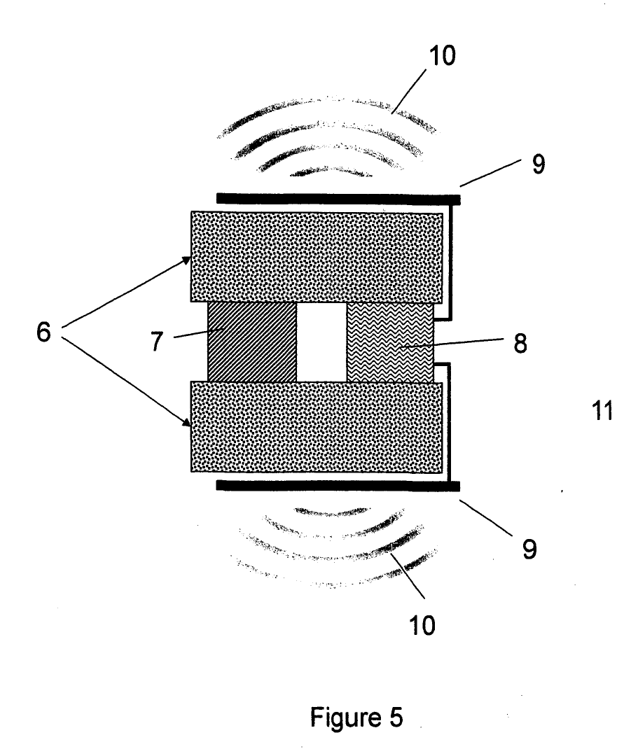

FIG. 6 is a cross-sectional view of an ingestible skin signal generator inside the stomach generating a skin signal authorizing a weapon;

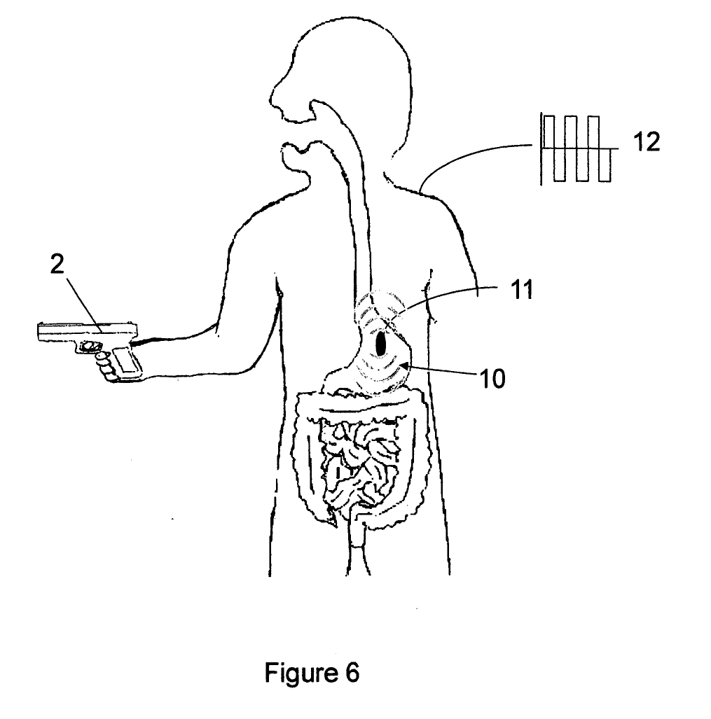

FIG. 7 is a view of a skin mounted skin signal generator mounted on a wrist generating a skin signal authorizing a weapon;

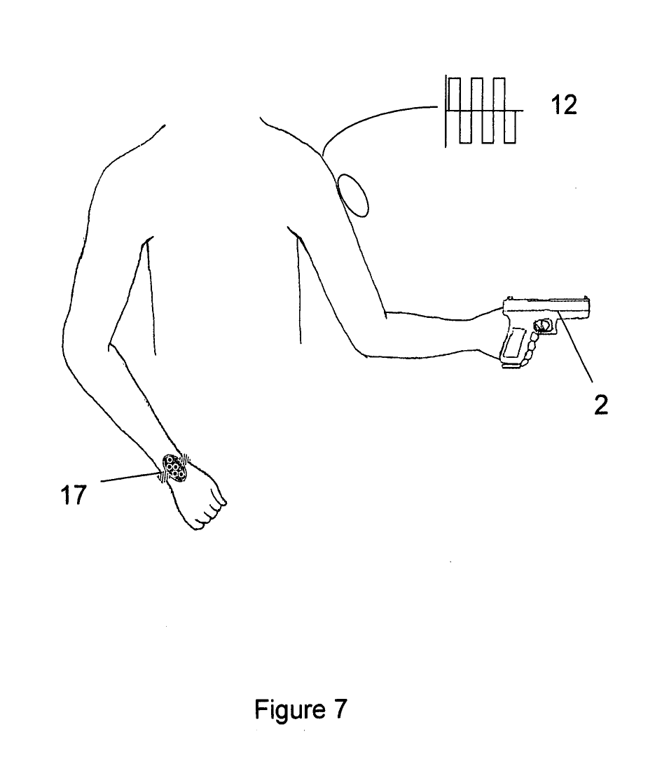

FIG. 8 is a side view of a skin mounted skin signal generator;

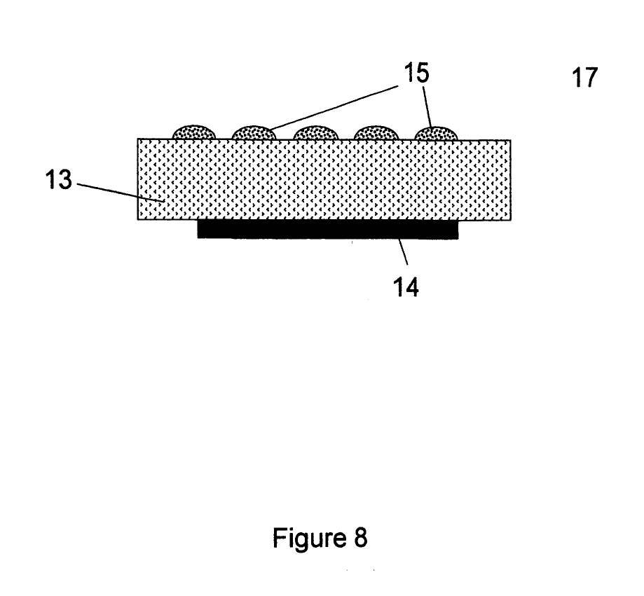

FIG. 9 is a plan view of a skin mounted skin signal generator, bottom;

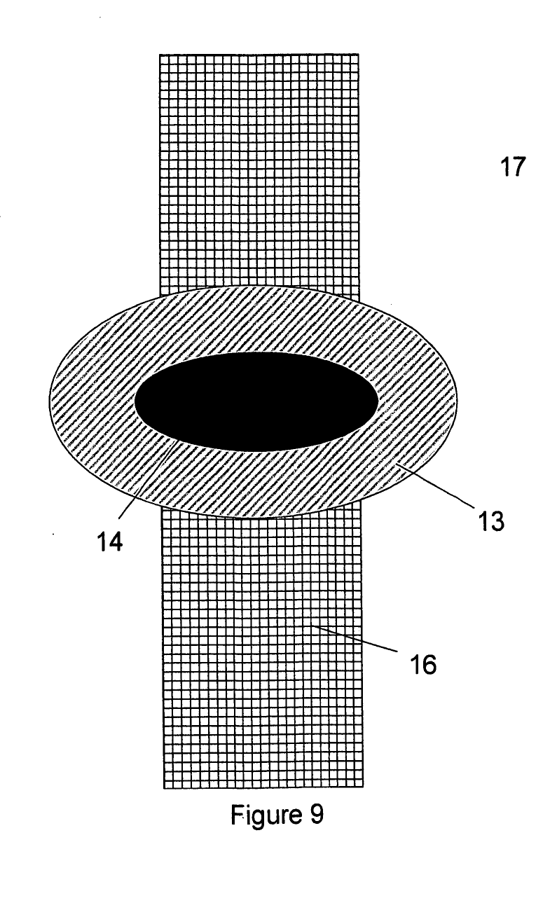

FIG. 10 is a plan view of a skin mounted skin signal generator, top;

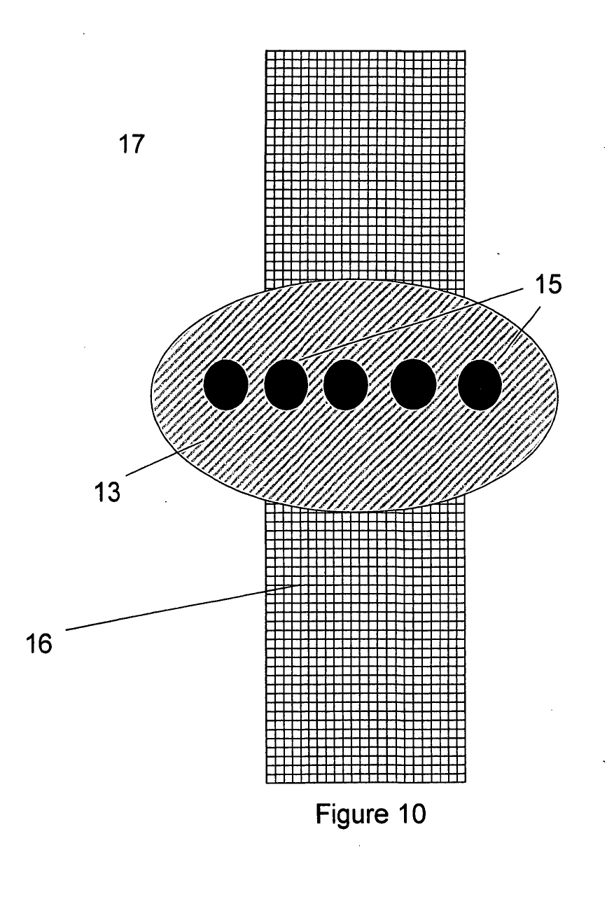

FIG. 11 is a view of a secured storage cabinet in closed condition;

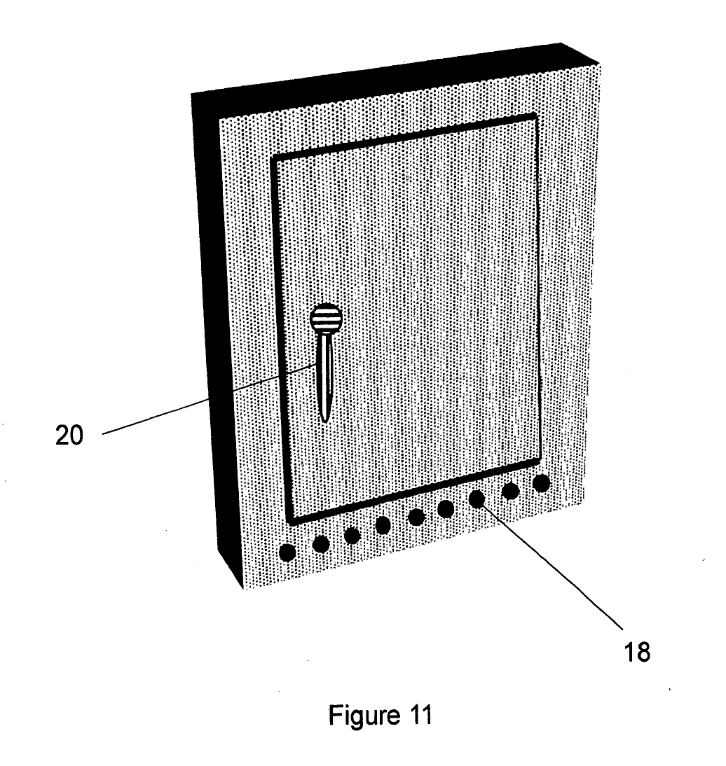

FIG. 12 is a view of a secured storage cabinet in open condition displaying the contents;

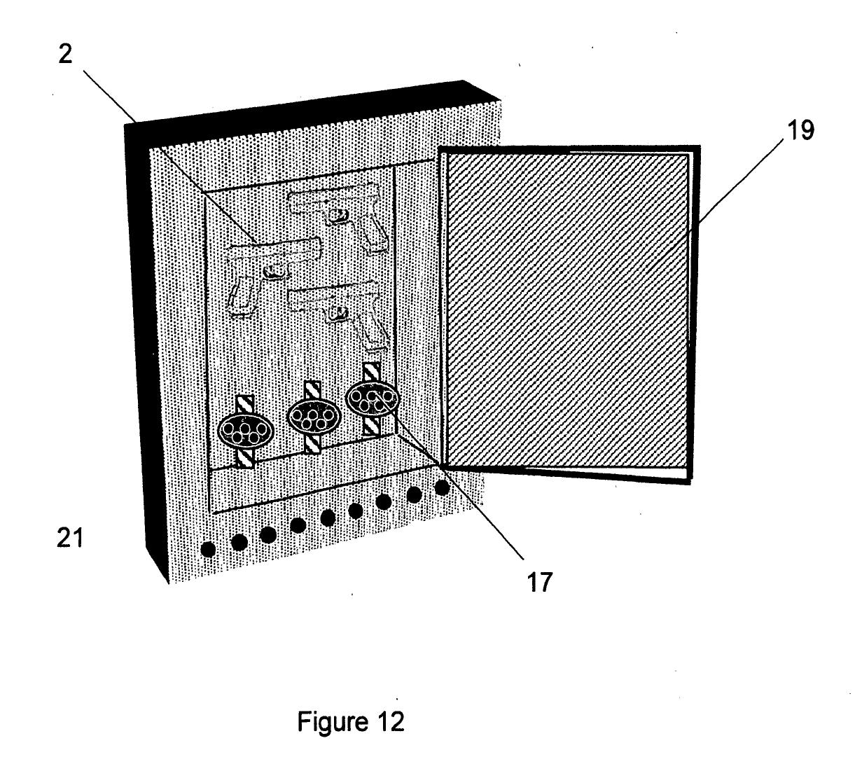

FIG. 13 is a flow chart for a method of authorizing and opening the secured storage cabinet;

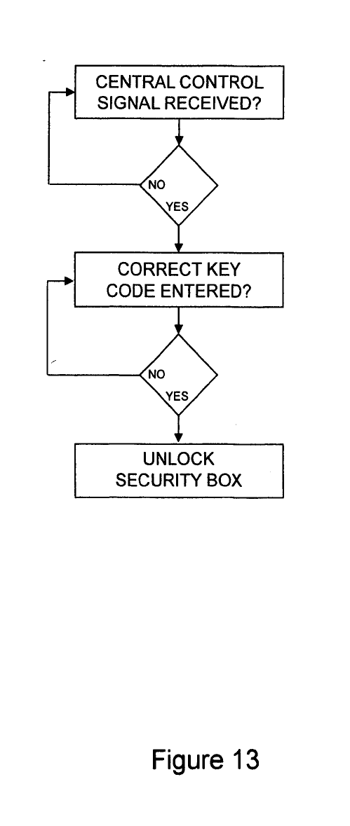

FIG. 14 is a plan view for the placement of secured storage cabinets around a school or institution.

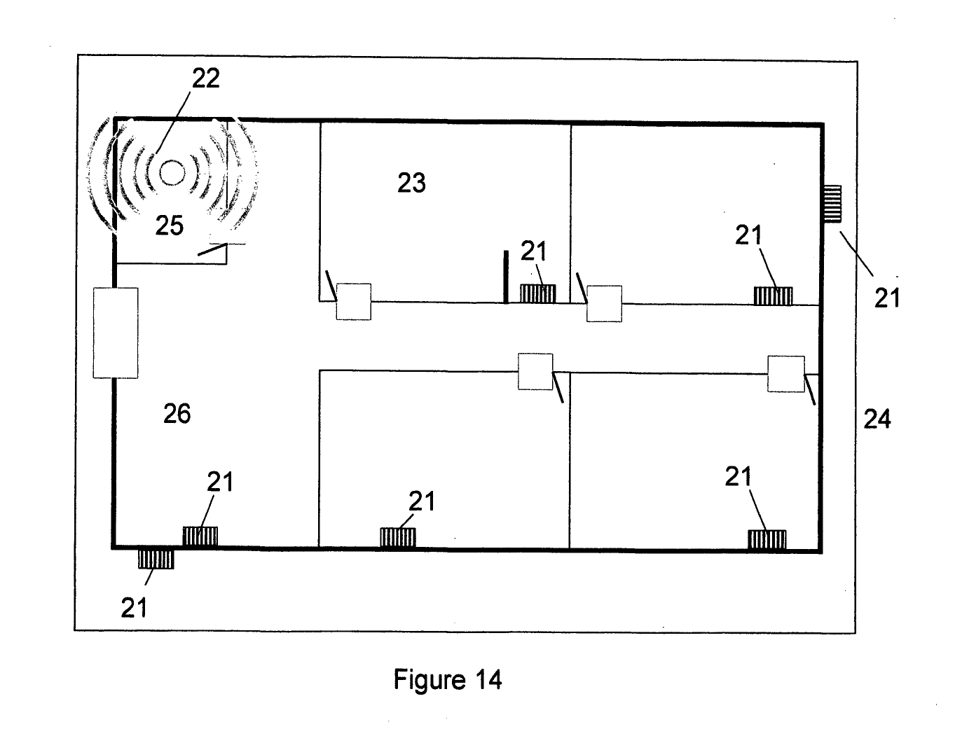

What is claimed is:

1. The method of a firearm authorization system, comprising:
(1) a firearm having a frame with a handle, a barrel carried by said frame, and a fire authorization and control system carried by said frame and in operational connection with said barrel, said fire authorization and control system adapted to authorize and allow the discharge of a bullet through said barrel;
(2) an authorizing device carried by said frame and adapted to receive and evaluate authorizing signals, said authorizing device placing the firearm in an operational condition when said authorizing device receives the predetermined one or more authorizing signals, and placing the firearm in a non-operational condition when said authorizing device does not receive the predetermined one or more authorizing signals;
(3) a receiver for one or more authorizing signals with at least one signal being detected from the surface of the skin of an individual, said signals being then connected to said authorizing device.

2. The method as in claim 1 wherein the authorizing signal further comprises a received radio wave.

3. The method as in claim 2 wherein the authorizing signal further comprises a received radio wave sent from an authorizing authority.

4. The method as in claim 1 wherein the authorizing signal further comprises an entered security code.

5. The method as in claim 1 wherein the frame further comprises video detection means.

7. The method as in claim 1 wherein the frame further comprises video recording means.

8. The method as in claim 1 wherein the frame further comprises video detection and transmission means.

9. The method as in claim 1 wherein the frame further comprises audio detection means.

10. The method as in claim 1 wherein the frame further comprises audio recording means.

11. The method as in claim 1 wherein the frame further comprises audio detection and transmission means.

12. The method as in claim 1 further comprising the authorizing signal received from the skin being generated by an ingested device.

13. The method as in claim 1 further comprising the authorizing signal received from the skin being generated by a signal generating device worn in contact with the skin.

14. The method of a storage cabinet, comprising:
(1) an enclosure defining a volume, a door providing access to said volume, a handle providing means for opening said door, further electronic means providing an externally mounted means for entering an authorizing code for opening said door, radio receiving means for receiving authorization of opening said door;
(2) an authorizing device carried within said volume and adapted to receive and evaluate authorizing signals, said authorizing device placing the door in an openable condition when said authorizing device receives the predetermined one or more authorizing signals, and placing the door in a non-openable condition when said authorizing device does not receive the predetermined one or more authorizing signals;
(3) said enclosure containing authorizable weapons and ingestible and skin mounted authorizing skin signal generating devices
(4) said enclosure containing means for maintaining the electrical charge and readiness of the contained devices.

15. A method of authorizing a device comprising:
(1) the detection of an authorizing signal from the skin of the individual in skin contact with the device;

16. The method of claim 15 further comprising the entering of a security code.

17. The method of claim 15 further comprising the receiving of an authorization by radio.

18. The method of claim 15 where the device is a weapon.

19. The method of claim 15 where the device is located in a school.
